(19) United States
(12) Patent Application Publication
(10) Pub. No.: US 2005/0148271 A1
(43) Pub. Date: Jul. 7, 2005

(54) Nanotubes cold cathode

(75) Inventors: Zvi Yaniv, Austin, TX (US); Richard Fink, Austin, TX (US); Dean Hutchins, Austin, TX (US); Mohshi Yang, Austin, TX (US); Leif Thuesen, Austin, TX (US)

Correspondence Address: Kelly K. Kordzik;Winstead Sechrest & Minick P.C., P.O. Box 50784, Dallas, TX, 75201, US

(73) Assignee: SI Diamond Technology, Inc., Austin, TX (US)

(21) Appl. No.: 11/008,409

(22) Filed: Dec. 9, 2004

Related U.S. Application Data
(62) Division of application No. 09/791,330, filed on Feb. 23, 2001.
(60) Provisional application No. 60/185,222, filed on Feb. 25, 2000.

(51) Int. Cl. H01J 9/12; H01J 9/04

(52) U.S. Cl. 445/50; 445/51; 445/49

(57) ABSTRACT

A two-layer approach is provided for thermally growing carbon nanotubes on a substrate for field emitter applications. An adhesion layer is deposited on a cathode. A catalyst layer is then deposited on the adhesion layer, and then a carbon nanotube film is grown on the catalyst layer.

### TECHNICAL FIELD

The present invention relates in general to field emission devices, and in particular, to field emission devices using carbon nanotubes.

### BACKGROUND INFORMATION

Carbon nanotubes are carbon fibers or rods that can be very long and very narrow. The length can be on the order of microns or tens of microns, the width on the order of nanometers, so the aspect ratio of height to width can be very high. Carbon nanotubes fall into a class of carbon materials called fullerenes. The tubes can have a single wall or multiple walls of carbon layers, the layers are similar to a sheet of graphite wrapped in a tube form. Nanotubes were first identified by S. lijima [S. lijima, Nature (London) Vol. 354, page 56, 1991. Nanotubes can be grown by several methods that fall into 3 categories.
1. Laser Vaporization Synthesis Method. This method involves the vaporization of a carbon rod by a laser in a high temperature argon environment. This method produces a felt-like material that is then harvested for studying the fibers. This method is not used for depositing directly onto a substrate.
2. Carbon Arc Discharge. This method creates an electric arc discharge current between carbon electrodes. The plasma between the carbon electrodes is on the order of 3000° C. or higher. This method produces nanotubes on the reactor walls and electrodes that are harvested for use. This method is generally not used for depositing directly onto substrates.
3. Vapor Growth or Thermal CVD Method: Fe, Co, and Ni particles are known to be catalysts for vapor grown carbon fiber synthesis. (M. Yudasaka, R. Kikuchi, Y. Ohki, E. Ota, and S. Yoshimura, “Behavior of Ni in Carbon Nanotube Nucleation,” Applied Physics Letters, Vol. 70, p. 1817, April 1997.) Similarly, these methods can be used for growing carbon nanotubes. This method has been recently used by many researchers to grow nanotubes directly onto substrates. An example of this work is given by Z. F. Ren, Z. P. Huang l. W. Z. Xu, J. H. Wang, P. Bush,, M. P. Siegal, P. N. Provencio, In “Synthesis of Large Arrays of Well-Aligned Carbon Nanotubes on Glass,” published in Science, Vol. 282, 6 Nov., 1998. This paper reports the growth of well aligned nanotubes on glass substrates at temperatures below 666° C. Field emission properties of these films are not discussed in this paper. In another paper from the Proceedings of the 13th International Winter School on Electronic Properties of Novel Materials, Feb. 27-Mar. 6, Kirchberg/Tirol, Austria (“Large Arrays of Well-Aligned Carbon Nanotubes,” Z. F. Ren, Z. P. Huang, J. W. Xu, d. Z. Wang, J. H Wang) the same authors describe patterning of nanotube growth by patterning the Ni film on the substrate. They also say that the nanotube growth temperature can be lowered to 500° C. by using ammonia in the reaction gas mixture of a PE-CVD reactor.

Carbon nanotubes have been used for some time in research and development of controllable, addressable electron sources, mainly for display applications. The field emission properties of carbon nanotubes have been discussed by many research groups. Some of these groups have even made displays. An example is “A nanotube-based field emission flat-panel display”, Q. H. Wang, A. A. Setlur, J. M Lauerhass. J. Y Dal, E. W. Seelig, Applied Physics Letters, Vol. 72, p. 2912, 1 Jun., 1998. This paper describes a matrix-addressed display that was fabricated using a carbon nanotube-epoxy composite as the electron emission source. Here the nanotubes were harvested from a carbon arc discharge reactor, mixed in an epoxy and attached to the substrates. Similar papers were published by Ise Electronics Corporation (S. Uamura, T. Nagasako, J. Yotani, T. Shimojo, Y. Saito, “Carbon Nanotube FED Elements,” SID Digest of Technical Papers, Vol. 24, p. 1052, May 1998.), Lucent Technologies (W. Zhu, C. Bower, O. Zhou, G. Kachanski, and S. Jin, “Large Current Density from Carbon Nanotube Field Emitters,” Applied Physics Letters, Vol. 75, p. 873, August 1999.) and Samsung Advanced Institute of Technology (Applied Physics Letters, Vol. 75, p. 3129, 15 Nov. 1999).

The problem with these technologies is that the nanotubes are grown in a separate reactor, harvested and than attached to a substrate using various means. These technologies generally do not produce good results and do not lead to a process that is manufacturable. One wishes to grow the carbon nanotubes directly onto the substrate in such a way that it is low temperature and gives a patterned carbon film. Because of this, one is limited to a thermal CVD method of fabricating the nanotubes, directly on the substrate. As described above, this has been demonstrated by patterning the Ni layer on the substrate (i.e. where there is Ni or other transition metal, there is growth; if there is no such metal, there is no growth.)

U.S. Pat. Nos. 5,872,422 and 5,973,444 describe a method of making a carbon nanotube display using this method. Here the claim is to make a display device using carbon emitters grown catalytically. They teach using Ni, Fe, Co and other transition metals for catalytically growing the carbon structures in a thermal CVD reactor. Other publications also discuss growing carbon nanotubes using catalytic methods using either Fe, Co or Ni films or particles or films and particles of compounds containing these elements. The problem with this approach is that the field emission properties of these films are not always good.
The transition metals may be taken up by the nanotube growth resulting in poor adhesion to the substrate.
The transition metals do not adhere well to the substrates.
The transition metal layer may not be compatible with other layers and processes required to make a working and manufacturable display.

These problems lead to arcing and electrical interruption during operation of the field emission device, poor life and poor emission quality.

### BRIEF DESCRIPTION OF THE DRAWINGS

FIGS. 1A and 1B illustrate a graph showing a comparison of emission properties between the present invention and the prior art;

FIGS. 2-5 illustrate the manufacture of a cathode in accordance with the present invention;

FIG. 6 illustrates a display device configured in accordance with the present invention; and

FIG. 7 illustrates a data processing system configured in accordance with the present invention.

### DETAILED DESCRIPTION

Overview

The present invention addresses the foregoing problems. The present invention demonstrates a carbon nanotube field emitter that is grown by thermal CVD using a Ni catalytic film that was deposited on an adhesion layer of Ti between the Ni film and the forsterite ceramic substrate. Several experiments were tried in which two samples were placed side by side in a thermal CVD reactor. Hydrogen (H2) and ethylene (C2H4) were used in the reactor to form the carbon film. On one substrate, a 1000 A layer of Ni was deposited directly onto clean forsterite (a ceramic material). On the other substrate, 1000 A of titanium (Ti) was deposited directly on the clean forsterite surface and then 1000 A of Ni was deposited on top of the Ti layer. The Ni was deposited by e-beam evaporation in the same deposition run for each substrate, so the Ni layer thickness is identical. Thus, since they were run side-by-side in the reactor and the only substrate fabrication difference was that one sample had Ti between the Ni layer and the forsterite substrate (“Ti+Ni”) and the other had only a Ni layer (“Ni only”), then the results of the experiment can be attributed to the sample preparation differences.

The results were as follows:

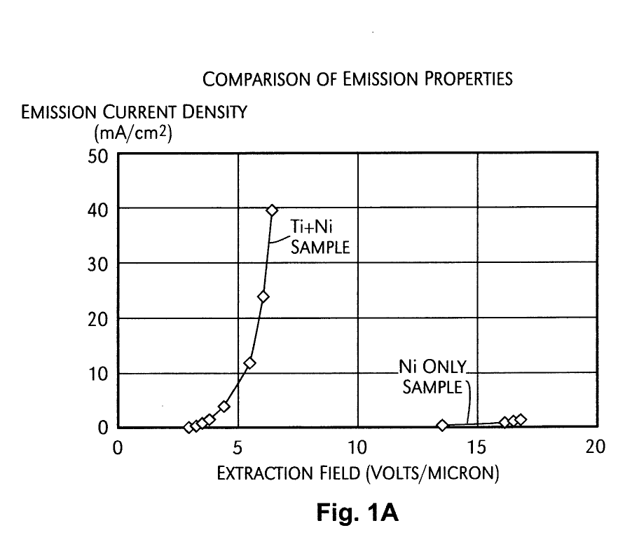

1. The “Ni only” sample was darker, in what appears to be very dense carbon growth. The “Ti+Ni” sample appeared gray with less dense growth by optical examination.
2. The “Ni only” sample was electrically nearly insulating when measuring the resistance across the growth surface (about 700,000 ohms across 1 cm). The “Ti+Ni” sample was electrically conducting with a resistance of below 2000 ohms across 1 cm. A conducting layer is needed to provide sufficient charge to the carbon emitters. [Note: It is not necessary that the Ni has disappeared from the sample in the “NI only” sample, but it may be taken up in the carbon film or in a state that is not conducting.]
3. The emission properties of the samples were dramatically different. The two graphs illustrated in FIGS. 1A and 1B show the emission on performance of the films. It can clearly be seen that the “Ti+Ni” sample gives more current and lower extraction voltages, which is very advantageous to display devices.
4. The adhesion of the carbon layer was very poor for the “Ni only” sample. After the field emission tests, the “Ni only” sample had obvious signs that the carbon film had come off the substrate during the emission tests.
   Comparison of Emission Properties

Having double metal layers or even multiple layers of metal, dielectrics, semiconductors and resistive materials can have many advantages in fabricating useful display devices.
One can use this multi-layer approach to pattern the carbon growth. One can hide the catalytic layer under a layer of material that does not promote carbon growth.
One can put double metal layers down and then selectively anodize one layer to form oxide layers. This is important for fabricating integrated cathode+grid structures on the sample substrates.
One can “tune” the resistance to the carbon emitter patches using bi-layer approach.

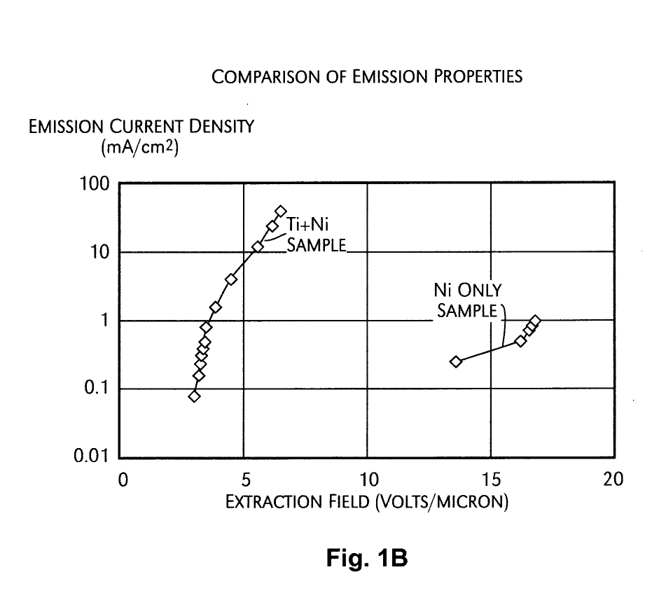

A process for constructing a bi-layer metallization structure of the present invention is illustrated with respect to FIGS. 2-5. Referring to FIG. 2, an insulated or conducting substrate 201 is cleaned for use in depositing metal films and carbon layers in accordance with the present invention. Referring to FIG. 3, the first layer, the adhesion layer, 301 is deposited on the substrate 201. As previously described, layer 301 can be a 1000 angstrom thick layer of Ti deposited by e-beam evaporation. Layer 301 can be other metals such as Cu, Cr, Nb, Mo, Ta, W, or alloys of these metals (e.g., TiW). For alumina substrates, a 100-500 angstrom Cr layer may be used for the application of the present invention. Layer 301 can be deposited by e-beam evaporation, thermal evaporation, sputtering, or other means of physical vapor deposition. Printing, spraying, painting or other coating mechanisms may also be used. This layer can be patterned by masking during deposition or by etching away material after deposition using standard photolithography and etching techniques known in the state of the art. Patterning may also be performed by selected anodization of the metal layer, turning the metal layer into an insulating or semiconducting or semi-metal layer that is an oxide or nitride compound of the initial metal layer.

Referring next to FIG. 4, a catalyst layer 401 is deposited on top of the adhesion layer 301. Layer 401 can be Ni, Fe, or Co or other material that promotes the growth of carbon nanotubes. Alloys of these metals with each other or with other metals may also be acceptable. As described previously, a 1000 angstrom layer of Ni is used. A range of 100-2000 angstroms of Ni, Fe or Co can also be used. The catalyst layer 401 can be deposited by e-beam evaporation, thermal evaporation, sputtering, or other means of physical vapor deposition. Printing, spraying, painting or other coating mechanisms may also be used. Layer 401 can be patterned by masking during deposition or by etching away material after deposition using standard photolithography in etching techniques know in the state of the art.

Referring to FIG. 5, a carbon nanotube film 501 is grown on top of the catalyst layer 401 by thermal CVD methods in a methane gas+hydrogen gas mixture at a temperature of 650-700 degrees centigrade and a pressure of about 760 Torr. Other temperature and pressure ranges may be possible, depending on the catalyst used and the hydrocarbon precursor gas used (acetylene will react at lower temperatures than methane gas). Radio waves, microwaves, DC glow or other plasma generation techniques may be used to excite the precursor gas into reacting with the catalyst. Afterwards the cathode 500 that has been created is removed and tested.

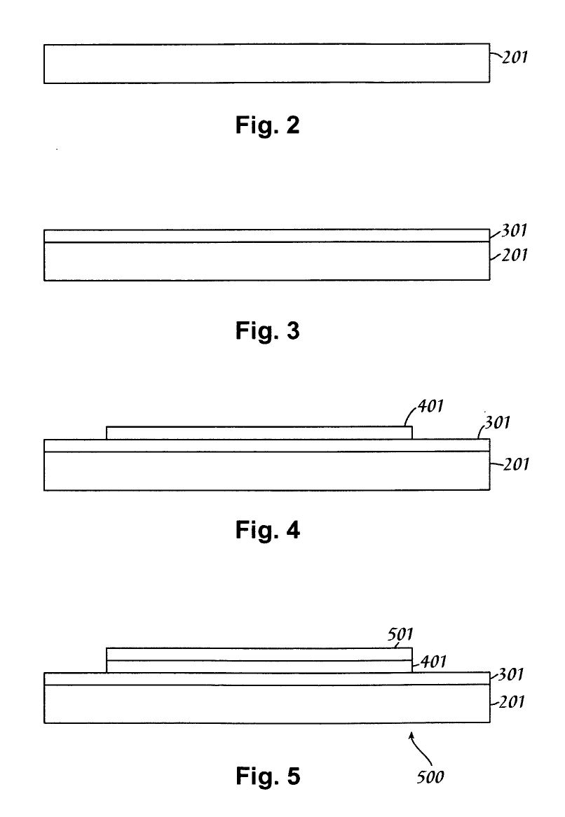

Referring to FIG. 6, a display device can be manufactured using the cathode 500 in combination with an anode 601 comprising a substrate 602, an indium tin layer 603 and a phosphor layer 604. The phosphor layer 604 will emit light in response to the receipt of electrons emitted from the cathode 500.

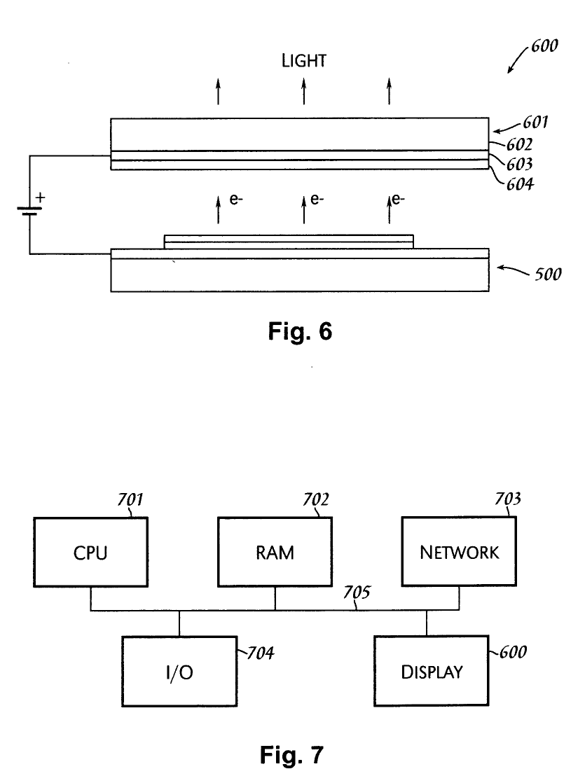

Referring to FIG. 7, a data processing system can be manufactured in accordance with the present invention where a CPU 701 is coupled by a system bus 705 to memory 702, input/output devices 704, and a network 703. Output from the data processing system can be provided using display 600 of FIG. 6.

### SUMMARY

The present invention describes a two-layer approach for thermally growing carbon nanotubes on a substrate for field emitter applications. One embodiment at this time is to place a layer of Ti between the Ni, Co, or Fe layer. This leads to improved emission performance of the carbon nanotube emitter.

1. (canceled)

2. A method for making a cathode comprising the steps of:
providing a substrate;
depositing an adhesion layer on the substrate;
depositing a catalyst layer on the adhesion layer; and
growing a carbon nanotube film on the catalyst layer.

3. The method as recited in claim 2, further comprising the step of patterning the adhesion and the catalyst layers before the growing step.
